(19) United States
(12) Patent Application Publication
(10) Pub. No.: US 2014/0022042 A1
(43) Pub. Date: Jan. 23, 2014

(54) CHIP DEVICE, MULTI-LAYERED CHIP DEVICE AND METHOD OF PRODUCING THE SAME

(71) Applicant: SAMSUNG ELECTRO-MECHANICS CO., LTD., Suwon (KR)

(72) Inventors: Sang Soo PARK, Suwon (KR); Young Ghyu AHN, Suwon (KR); Min Cheol PARK, Suwon (KR)

(73) Assignee: SAMSUNG ELECTRO-MECHANICS CO., LTD., Suwon (KR)

(21) Appl. No.: 13/740,738

(22) Filed: Jan. 14, 2013

(30) Foreign Application Priority Data
Jul. 18, 2012 (KR) 10-2012-0078422

(51) Int. Cl. H01F 17/00; H01F 41/00

(52) U.S. Cl. CPC H01F 17/0013; H01F 41/00
USPC 336/200; 29/602.1

(57) ABSTRACT

There is provided a multi-layered chip device, including: a multi-layered body in which a plurality of inner magnetic layers are stacked; an inner electrode layer formed within the multi-layered body; an outer magnetic layer stacked on at least one of an upper surface and a lower surface of the multi-layered body; and external electrodes formed on outside of the multi-layered body and the outer magnetic layer and electrically connected to the inner electrode layer, wherein a length of the outer magnetic layer is shorter than the inner magnetic layer.

### CROSS-REFERENCE TO RELATED APPLICATIONS

This application claims the priority of Korean Patent Application No. 10-2012-0078422 filed on Jul. 18, 2012, in the Korean Intellectual Property Office, the disclosure of which is incorporated herein by reference.

### BACKGROUND OF THE INVENTION

1. Field of the Invention

The present invention relates to a chip device, a multi-layered chip device, and a method of producing the same.

2. Description of the Related Art

An inductor, a multi-layered chip component, is a representative passive element capable of removing noise from a signal by being included in an electronic circuit together with a resistor and a capacitor.

A multi-layered chip type inductor may be manufactured by printing and stacking conductive patterns so as to form a coil within a magnetic substance or a dielectric substance. The multi-layered chip inductor has a structure in which a plurality of magnetic layers on which conductive patterns are formed are stacked. Conductive patterns within the multi-layered chip inductor are sequentially connected by via electrodes formed in each magnetic layer so as to form a coil structure within a chip to implement characteristics such as targeted inductance and impedance therein.

Meanwhile, as electronic devices become slim and light, demand for simplification of a power inductor structure has been increased. In particular, demand for small, high-performance inductors has increased.

### RELATED ART DOCUMENT

Japanese Patent Laid-Open Publication No. 2001-155950

### SUMMARY OF THE INVENTION

An aspect of the present invention provides a chip device having excellent electrical characteristics while being miniaturized and a method of producing the same.

Another aspect of the present invention provides a chip device with excellent inductance characteristics, able to be easily mass-produced, and a method of producing the same.

According to an aspect of the present invention, there is provided a multi-layered chip device, including: a multi-layered body in which a plurality of inner magnetic layers are stacked; an inner electrode layer formed within the multi-layered body; an outer magnetic layer stacked on at least one of an upper surface and a lower surface of the multi-layered body; and external electrodes formed on outside of the multi-layered body and the outer magnetic layer and electrically connected to the inner electrode layer, wherein a length of the outer magnetic layer is shorter than the inner magnetic layer.

According to another aspect of the present invention, there is provided a method of producing a multi-layered chip device, including: preparing a plurality of inner magnetic layers on which conductive patterns and via electrodes are formed; forming a multi-layered body by stacking the plurality of inner magnetic layers so as to form a coil part by contacting ends of the conductive pattern formed in each of the inner magnetic layers with via electrodes formed in adjacent first magnetic layers; stacking an outer magnetic layer on at least one of an upper surface and a lower surface of the multi-layered body; and forming external electrodes on outside of the multi-layered outer magnetic layer and the multi-layered body, wherein the outer magnetic layer is shorter than the inner magnetic layer.

According to another aspect of the present invention, there is provided a method of producing a multi-layered chip device, including: preparing a plurality of inner magnetic layers on which conductive patterns and via electrodes are formed; forming a multi-layered body by stacking the plurality of inner magnetic layers so as to form a coil part by contacting ends of the conductive pattern formed in each of the inner magnetic layers to the via electrodes formed in adjacent inner magnetic layers; stacking an outer magnetic layer on at least one of an upper surface and a lower surface of the multi-layered body; partially removing both ends in a length direction of the multi-layered outer magnetic layer; and forming external electrodes on outside of the outer magnetic layer of which the both ends are partially removed and the multi-layered body.

According to another aspect of the present invention, there is provided a chip device, including: a support substrate; coils formed on both surfaces of the support substrate; a magnetic body including the coils and the support substrate and formed of a magnetic substance; an outer magnetic layer formed on at least one of an upper surface and a lower surface of the magnetic body; and external electrodes formed on outside of the multi-layered body and the outer magnetic layer and electrically connected to the coils, wherein a length of the outer magnetic layer is shorter than that of the magnetic body.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a partially cutaway perspective view of a multi-layered chip inductor according to an embodiment of the present invention;

FIG. 2 is a schematically exploded perspective view of a stacked appearance of the multi-layered chip inductor of FIG. 1;

FIG. 3 is a schematic plan view showing an appearance of conductive patterns formed on magnetic layers of FIG. 1;

FIGS. 4A and 4B are schematic cross-sectional views taken along line V-V′ of FIG. 1;

FIG. 5 is a cross-sectional view of a multi-layered inductor according to another embodiment of the present invention;

FIG. 6A through 6C are diagrams illustrating a method of producing a multi-layered inductor according to an embodiment of the present invention;

FIG. 7A through 7D are diagrams illustrating a method of producing a multi-layered inductor according to another embodiment of the present invention;

FIGS. 8A through 8C are diagrams showing an inductor according to another embodiment of the present invention; and

FIG. 9 is a schematic cross-sectional view taken along line U-U′ of FIG. 8.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

In addition, singular forms used in the specification are intended to include plural forms unless the context clearly indicates otherwise. In the specification, it is to be noted that the terms “comprising” or “including”, and the like, are not to be construed as necessarily including several components or several steps described in the specification, and some of the above components or steps may not be included or additional components or steps are construed as being further included.

Terms used in the specification, ‘first’, ‘second’, etc. can be used to describe various components, but the components are not to be construed as being limited to the terms. The terms are used to distinguish one component from another component. For example, the ‘first’ component may be named the ‘second’ component and the ‘second’ component may also be similarly named the ‘first’ component, without departing from the scope of the present invention.

A chip device according to an embodiment of the present invention may be appropriately applied as a chip inductor in which conductive patterns are formed on magnetic layers, a power inductor, chip beads, a chip filter, and the like.

Hereinafter, embodiments of the present invention will be described with reference to a multi-layered chip inductor.

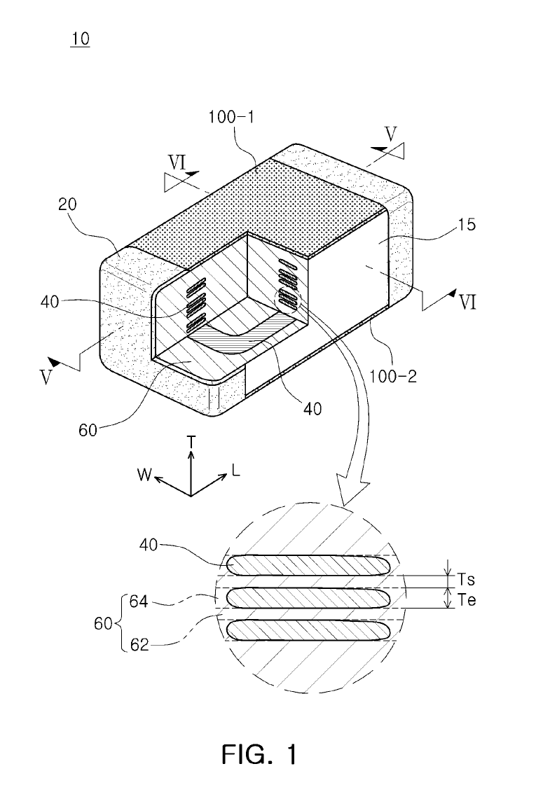

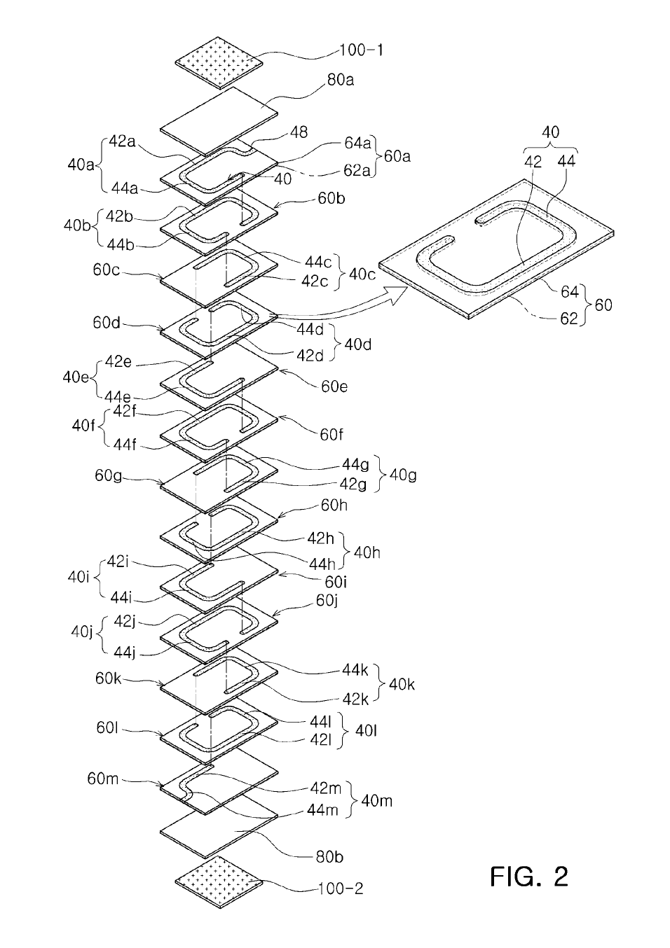

FIG. 1 is a partially cutaway perspective view of a multi-layered chip inductor according to an embodiment of the present invention and FIG. 2 is a schematically exploded perspective view of a stacked appearance of the multi-layered chip inductor of FIG. 1.

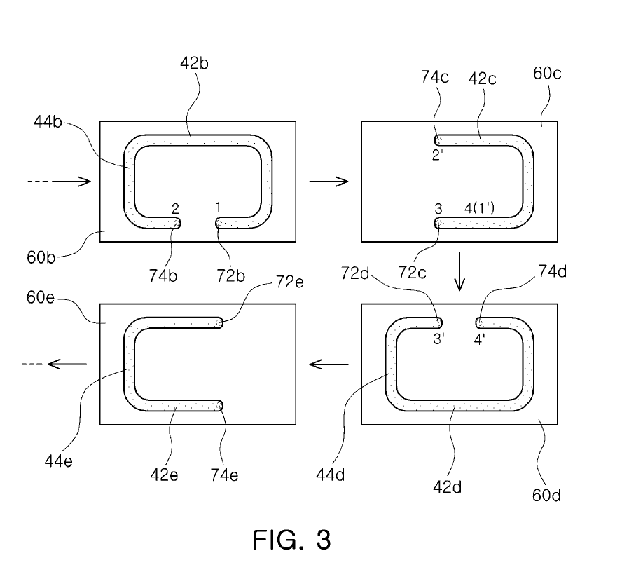

FIG. 3 is a schematic plan view showing an appearance of conductive patterns formed on magnetic layers of FIG. 1.

Referring to FIGS. 1 to 3, a multi-layered chip inductor 10 may include a multi-layered body 15, conductive patterns 40, a magnetic layer 62, outer magnetic layers 100-1 and 100-2, and external electrodes 20. The magnetic layer 62 may be generally referred to as an inner magnetic layer.

In addition, according to another embodiment of the present invention, the multi-layered chip inductor 10 may further include an additional magnetic layer 64. However, the multi-layered chip inductor 10 does not necessarily include the magnetic layer 64 as an essential component.

The multi-layered body 15 may be manufactured by printing the conductive patterns 40 on magnetic green sheets and stacking and sintering the magnetic green sheets on which the conductive patterns 40 have been formed.

The multi-layered body 15 may have a hexahedral shape. When the magnetic green sheets are stacked and sintered as a chip, the multi-layered body 15 may not be formed to have a hexahedral shape having a complete straight line due to a sintering shrinkage of ceramic powders. However, the multi-layered body 15 may be substantially formed to have a hexahedral shape.

When defining a hexahedral direction in order to clearly describe embodiments of the present invention, L, W, and T shown in FIG. 1 each represent a length direction, a width direction, and a thickness direction. Here, the thickness direction may be used as the same concept as a direction in which the magnetic layers are stacked.

According to the embodiment of FIG. 1, the multi-layered chip inductor 10 has a rectangular parallelepiped shape in which the length is larger than the width or thickness.

Meanwhile, a size of the multi-layered chip inductor 10 according to an embodiment of the present invention may have a length and a width within a range of 2.5±0.1 mm and 2.0±0.1 mm (2520 size), or may also be formed to have 2520 size or below, or 2520 size or more, including the external electrodes 20.

The magnetic layer 62 may be formed of a Ni—Cu—Zn-based material, a Ni—Cu—Zn—Mg-based material, a Mn—Zn and ferrite-based material, but the embodiment of the present invention is not limited thereto.

Referring to FIG. 1, the outer magnetic layer 100-1 may be stacked on an upper surface of the multi-layered body 15. In addition, the outer magnetic layer 100-2 may be stacked on a lower surface of the multi-layered body 15.

A length of the outer magnetic layer 100-1 may be shorter than that of the inner magnetic layer 62. The reason is that when the outer magnetic layer 100-1 is stacked on the upper surface of the multi-layered body 15, the external electrodes need to be formed around the upper surface of the multi-layered body 15 that is not covered by the outer magnetic layer 100-1. In addition, the reason is that when the outer magnetic layer 100-2 is stacked on the lower surface of the multi-layered body 15, the external electrodes 20 need to be formed around the lower surface of the multi-layered body 15 that is not covered by the outer magnetic layer 100-2.

Meanwhile, the outer magnetic layers 100-1 and 100-2 may be formed of the same material as a material used to form the inner magnetic layer 62.

The conductive patterns 40 may be formed by printing a conductive paste using silver (Ag) as a main component at a predetermined thickness. The conductive patterns 40 may be electrically connected to the external electrodes 20 that are formed at both longitudinal ends.

The external electrodes 20 are formed at both longitudinal ends of the ceramic body 15 and may be formed by electroplating an alloy selected from Cu, Ni, Sn, Ag, and Pd. However, the embodiment of the present invention is not limited to these materials.

The conductive patterns 40 may include leads that are electrically connected to the external electrodes 20.

Referring to FIG. 2, a conductive pattern 40a on a single multi-layered carrier 60a includes a conductive pattern 42a in a length direction and a conductive pattern 44a in a width direction. The conductive pattern 40a is electrically connected to a conductive pattern 40b on another multi-layered carrier 60b having a magnetic layer 62a disposed therebetween through via electrodes formed on the magnetic layer 62a to thus form coil patterns in a multi-layered direction.

All the coil patterns according to the embodiment of the present invention have a turn number of 9.5 times, but the embodiment of the present invention is not limited thereto. In order for the coil patterns 50 to have a turn number of 9.5 times, thirteen multi-layered carriers 60a, 60b, . . . , 60m in which conductive patterns 40a, 40b, . . . , 40m are formed are disposed between upper and lower magnetic layers 80a and 80b forming a cover layer.

The embodiment of the present invention discloses the conductive patterns 42a and 44b requiring two multi-layered carriers so as to form the coil pattern 50 having a turn number of one time, but is not limited thereto and therefore, may require different number of multi-layered carriers according to a shape of the conductive pattern.

Here, excellent DC bias characteristics may be provided within the limited multi-layered body 15 by reducing an interval between the magnetic layers between the upper conductive pattern 40a and the lower conductive pattern 40b that face each other in the multi-layered direction, having the magnetic layer 62a therebetween. When the interval between the magnetic layers can be reduced, the thickness of the conductive patterns 42a and 44a is increased and thus, the resistance of current flowing in a coil may be reduced.

Meanwhile, the outer magnetic layer 100-1 may be disposed on the magnetic layer 80a. Further, the outer magnetic layer 100-2 may be disposed under the magnetic layer 80b. In this case, the outer magnetic layers 100-1 and 100-2 may increase the inductance of the multi-layered inductor without increasing DC resistance. Also, as described above, the length of the outer magnetic layers 100-1 and 100-2 may be shorter than that of the inner magnetic layer.

In addition, the outer magnetic layer 100-1 may be disposed so that a center of the outer magnetic layer 100-1 corresponds to a center of the magnetic layer 80a. Also, the outer magnetic layer 100-2 may be disposed so that a center of the outer magnetic layer 100-2 corresponds to a center of the magnetic layer 80b.

Describing one-time turn of the coil pattern 50 with reference to FIG. 3, when a single via electrode 72b is defined as 1 and another via electrode 74b is defined as 2, in the conductive pattern 40b formed on a single magnetic layer, a via electrode 72c of the lower conductive pattern 42c in the multi-layered direction, corresponding to the 2, is defined as 3, and an opposite point of the conductive pattern 42c of a dielectric layer 60c, facing the 1, is defined as 4; one-time turn (1→2→3→4) is formed counterclockwise from 1, which may be defined as one turn.

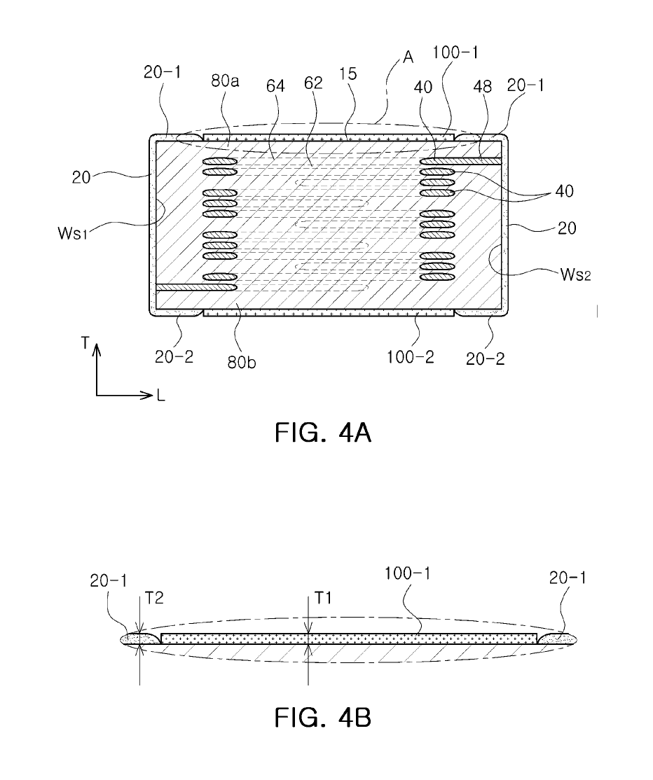

FIGS. 4A and 4B are schematic cross-sectional views taken along line V-V′ of FIG. 1.

The multi-layered chip inductor of FIG. 1 is cut in a length direction L and a thickness direction T shown in FIGS. 4A and 4B.

Referring to FIGS. 4A and 4B, when the multi-layered chip inductor is viewed in the length direction L and the thickness direction T, leads 48 that are electrically connected to the external electrodes 20 are formed on top and bottom magnetic layers on which the conductive patterns 40 are formed. The leads 48 are exposed to ends Ws1 and Ws2 in a length direction of the ceramic body 15 and are electrically connected to the external electrodes 20.

The conductive patterns 40 may be disposed to face each other within the multi-layered body 15, having the magnetic layer 62 therebetween.

Meanwhile, the outer magnetic layer 100-1 may be stacked on the multi-layered body 15. The outer magnetic layer 100-1 may be disposed between upper portions 20-1 of both external electrodes 20. Further, both ends in the length direction L of the outer magnetic layer 100-1 may be in contact with the upper portions 20-1 of the external electrodes.

Meanwhile, the outer magnetic layer 100-2 may be stacked on the lower surface of the multi-layered body 15. The outer magnetic layer 100-2 may be disposed between lower portions 20-2 of both external electrodes 20. Further, both ends in the length direction L of the outer magnetic layer 100-2 may be in contact with the lower portions 20-2 of the external electrodes 20.

FIG. 4B is an enlarged cross-sectional view of portion A of FIG. 4A.

As shown in FIG. 4B, a thickness T1 of the outer magnetic layer 100-1 may be determined based on a thickness T2 of the upper portion 20-1 of the outer electrode. According to the embodiment of the present invention, the thickness T1 of the outer magnetic layer 100-1 may be equal to the thickness T2 of the upper portion of the external electrode. Also, the thickness T1 of the outer magnetic layer 100-1 may be 0.9 to 1.1 times of the thickness T2 of the upper portion of the external electrode.

Since a stacking height of the outer magnetic layer 100-1 is similar to the thickness T2 of the upper portion of the external electrode, the inductance of the multi-layered inductor may be increased without increasing the entire chip height of the multi-layered inductor.

Meanwhile, the thickness of the outer magnetic layer 100-2 and the thickness of the lower portion 20-2 of the external electrode may satisfy the above relationship.

Meanwhile, the inductance of the multi-layered chip inductor having 2520 size was measured by adopting the configuration of the present invention. Reviewing simulation results, the multi-layered inductor adopting the outer magnetic layers 100-1 and 100-2 had inductance about 2% higher than in the configuration of the related art in which the outer magnetic layers 100-1 and 100-2 are not adopted.

That is, a product in which ferrite is formed at the same height as the external electrode may have improve initial inductance and DC bias characteristics as compare with the existing products. For example, when comparing the inductor according to the present invention with the inductor according to the related art at the same height, the inductor according the present invention shows the improved initial inductance and DC bias characteristics.

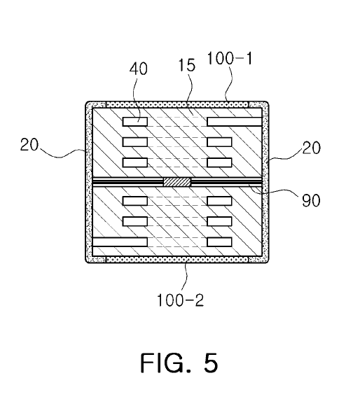

FIG. 5 is a cross-sectional view of a multi-layered inductor according to another embodiment of the present invention.

Generally, in the multi-layered inductor, the magnetic layers and the conductive patterns are alternately stacked, and the conductor patterns may be formed of coil conductors electrically connected to each other between the layers.

However, the multi-layered inductor as described above may suddenly degrade the inductance due to the occurrence of magnetic saturation of the magnetic substance due to the increase in current when DC current is applied thereto.

That is, the multi-layered inductor as described above may have a defect of the deterioration in DC overlapping characteristics.

For this reason, the multi-layered inductor having a magnetic gap part in which a part of the magnetic layer is substituted into a non-magnetic substance. The multi-layered inductor including the magnetic gap part may suppress the magnetic saturation occurring when the DC current is applied thereto, thereby improving the DC current overlapping characteristics.

According to the embodiment of the present invention, the multi-layered inductor including a magnetic gap 90 may include the outer magnetic layers 100-1 and 100-2.

The multi-layered inductor as described above suppresses the magnetic saturation, thereby improving the DC current overlapping characteristics and increasing the inductance.

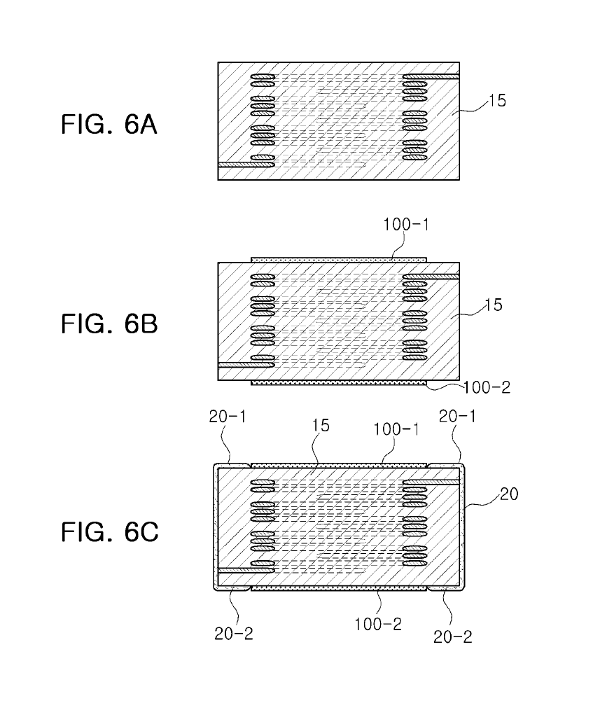

FIG. 6A through 6C are diagrams illustrating a method of producing a multi-layered inductor according to an embodiment of the present invention.

According to the embodiment of the present invention, as shown in FIG. 6A, the multi-layered body 15 may be prepared. The multi-layered body 15 may be formed by the stacking method as shown in FIG. 2. In addition, the multi-layered body 15 may be formed by various methods in addition to the stacking method as shown in FIG. 2.

Referring to FIG. 6B, the outer magnetic layer 100-1 may be stacked on the upper surface of the multi-layered body 15. Further, the outer magnetic layer 100-2 may be stacked on the lower surface of the multi-layered body 15.

The length of the outer magnetic layer 100-1 may be determined based on the lengths of the outer magnetic layers 100-1 and 100-2 and the upper portions 20-1 of the external electrodes that are formed on external surfaces of the multi-layered body 15. For example, the length of the outer magnetic layer 100-1 may be formed to be equal to a distance between ends of the upper portions 20-1 of both external electrodes. In addition, the length of the outer magnetic layer 100-2 may be determined based on the lengths of the outer magnetic layers 100-2 and 100-2 and the lower portions 20-2 of the external electrodes that are formed on external surfaces of the multi-layered body 15.

As such, in the process of preparing the outer magnetic layers having the length as described above, there is no need to perform an additional process of cutting the outer magnetic layer, such that the multi-layered process time may be shortened.

In addition, in the process described above, inductor performance may be improved without being degraded therefor due to remnants generated during the cutting of the outer magnetic layer.

Meanwhile, the outer magnetic layers 100-1 and 100-2 may be stacked on the upper and lower surfaces of the multi-layered body 15. In addition, the outer magnetic layer may be stacked only on one surface of the upper and lower surfaces of the multi-layered body 15 as needed.

As shown in FIG. 6C, the external electrodes 20 may be formed on outside of the multi-layered outer magnetic layers 100-1 and 100-2 and the multi-layered body.

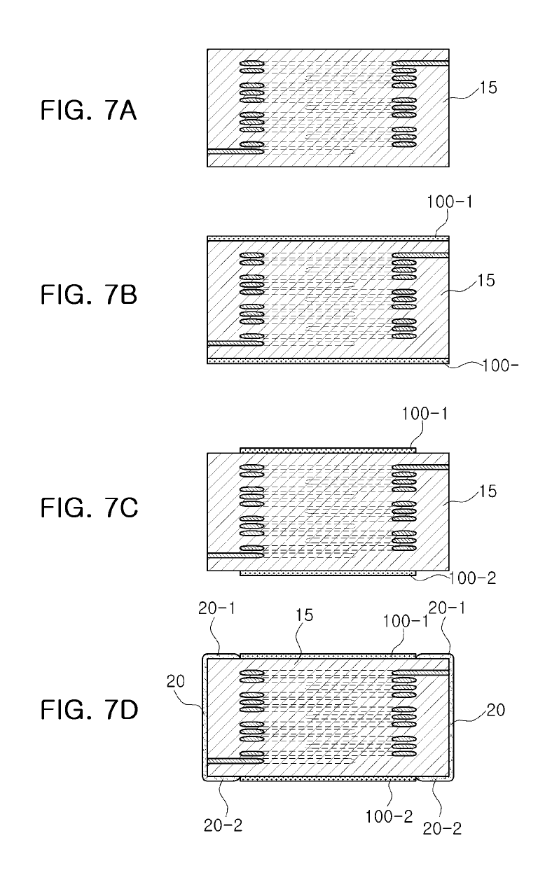

FIGS. 7A through 7D are diagrams illustrating a method of producing a multi-layered inductor according to another embodiment of the present invention.

According to the embodiment of the present invention, as shown in FIG. 7A, the multi-layered body 15 may be prepared. The multi-layered body 15 may be formed by the stacking method as shown in FIG. 2. In addition, the multi-layered body 15 may be formed by various methods in addition to the stacking method shown in FIG. 2.

Referring to FIG. 7B, the outer magnetic layer 100-1 may be stacked on the upper surface of the multi-layered body 15. Also, the outer magnetic layer 100-2 may be stacked on the lower surface of the multi-layered body 15.

In this case, the length of the outer magnetic layers stacked on the upper surface and/or the lower surface of the multi-layered body 15 may be equal to the length of the inner magnetic layer configuring the multi-layered body 15.

In this case, since the magnetic substance used to form the multi-layered body 15 may be used for forming the outer magnetic layer, the process may not require a process of separately preparing the outer magnetic substance.

Referring to FIG. 7C, portions of both ends of the outer magnetic layers 100-1 and 100-2 stacked on the upper surface and/or the lower surface of the multi-layered body 15 may be cut based on the lengths of the upper and lower portions of the external electrodes.

The lengths of the cut outer magnetic layer 100-1 and 100-2 may be determined based on the lengths of the outer magnetic layers 100-1 and 100-2 and the lengths of the upper and lower portions of the external electrodes that are formed on external surfaces of the multi-layered body 15.

For example, the length of the cut outer magnetic layer may be equal to the length between the ends of the upper portions of both external electrodes and the length between the ends of the lower portions of both external electrodes.

Referring to FIG. 7C, the external electrodes 20 may be formed on outside of the multi-layered outer magnetic layers 100-1 and 100-2 and the multi-layered body.

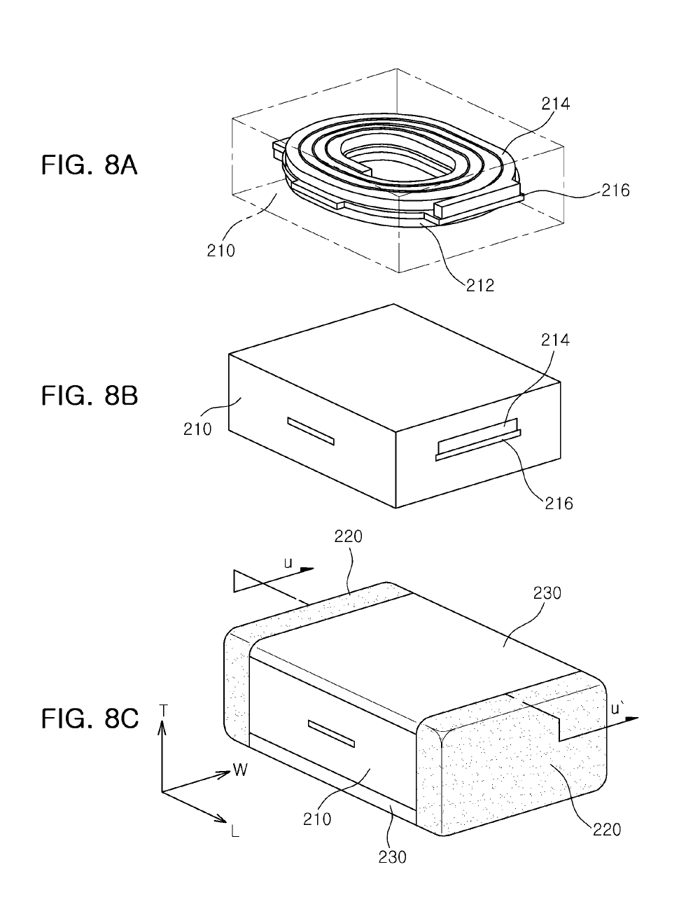

FIGS. 8A through 8C are diagrams showing an inductor according to another embodiment of the present invention.

The configuration of the outer magnetic layer as described above may be applied to the plane inductor.

Referring to FIG. 8A, a coil 241 may be formed on an upper surface of a support substrate 216. In addition, a coil 212 may be formed on a bottom surface of the support substrate 216.

Referring to FIG. 8B, a magnetic body 210 may be formed to include the support substrate 216 and the coils 212 and 214. In addition, the magnetic body 210 may be formed of a magnetic substance.

Referring to FIG. 8C, the respective external electrodes 220-1 and 220-2 may be formed so as to contact one end of the coil.

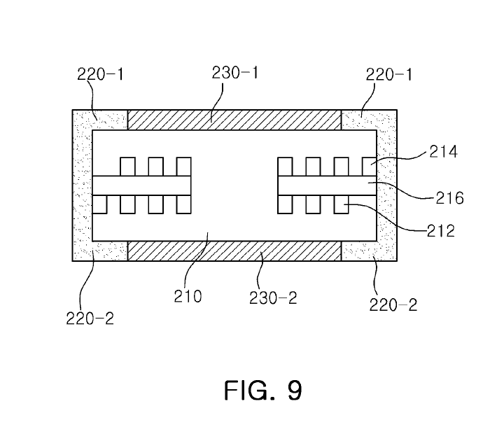

FIG. 9 is a schematic cross-sectional view taken along line U-U′ of FIG. 8C.

The plane inductor of FIGS. 8A to 8C is cut in a length direction L and a thickness direction T shown in FIG. 9.

Referring to FIG. 9, when the plane inductor is viewed in the length direction L and the thickness direction T, the coil 214 may be electrically connected to the external electrode 220-1 and the coil 212 may be electrically connected to the external electrode 220-2.

Meanwhile, an outer magnetic layer 230-1 may be stacked on the upper surface of the multi-layered body 210. The outer magnetic layer 230-1 may be disposed between upper portions 220-1 of both external electrodes 220. Further, both ends of the outer magnetic layer 230-1 in the length direction L thereof may be in contact with the upper portion 220-1 of the external electrode.

Meanwhile, an outer magnetic layer 230-2 may be stacked on the lower surface of the multi-layered body 210. The outer magnetic layer 230-2 may be disposed between bottom portions 220-2 of both external electrodes 220. In addition, both ends of the outer magnetic layer 230-2 in the length direction L thereof may be in contact with the bottom portion 220-2 of the external electrode.

As shown in FIG. 9, the length of the outer magnetic layers 230-1 and 230-2 is shorter than that of the magnetic body 210.

As described above, the configuration of the outer magnetic layer according to the embodiment of the present invention may be applied to various inductors, regardless of the shape of the body.

As set forth above, according to embodiments of the present invention, the chip device with excellent electrical characteristics while being miniaturized, and the method of producing the same, may be provided to users.

Further, the chip device with excellent inductance characteristics while being easily mass-produced and the method of producing the same may be provided to users.

While the present invention has been shown and described in connection with the embodiments, it will be apparent to those skilled in the art that modifications and variations can be made without departing from the spirit and scope of the invention as defined by the appended claims.

1. A multi-layered chip device, comprising:
a multi-layered body including a plurality of inner magnetic layers stacked therein;
an inner electrode layer formed within the multi-layered body;
an outer magnetic layer stacked on at least one of an upper surface and a lower surface of the multi-layered body; and
external electrodes formed on outside of the multi-layered body and the outer magnetic layer and electrically connected to the inner electrode layer,
a length of the outer magnetic layer being shorter than the inner magnetic layer.

2. The multi-layered chip device of claim 1, wherein a thickness of the outer magnetic layer is 0.9 to 1.1 times of that of the external electrode formed on the outside of the outer magnetic layer.

3. The multi-layered chip device of claim 1, wherein a thickness of the outer magnetic layer is equal to that of the external electrode formed on the outside of the outer magnetic layer.

4. The multi-layered chip device of claim 1, wherein a length and a width of the multi-layered chip device have a range of 2.5±0.1 mm and 2.0±0.1 mm.

5. The multi-layered chip device of claim 1, wherein the outer magnetic layer includes the same material as the inner magnetic layer.

6. The multi-layered chip device of claim 1, further comprising a non-magnetic layer formed in the multi-layered body.

7. The multi-layered chip device of claim 1, wherein the inner electrode layer includes silver (Ag).

8. The multi-layered chip device of claim 1, wherein the external electrode includes at least one of silver (Ag) and copper (Cu).

9. A method of producing a multi-layered chip device, comprising:
preparing a plurality of inner magnetic layers including conductive patterns and via electrodes formed thereon;
forming a multi-layered body by stacking the plurality of inner magnetic layers so as to form a coil part by contacting ends of the conductive pattern formed in each of the inner magnetic layers with the via electrodes formed in adjacent first magnetic layers;
stacking an outer magnetic layer on at least one of an upper surface and a lower surface of the multi-layered body; and
forming external electrodes on outside of the multi-layered outer magnetic layer and the multi-layered body,
the outer magnetic layer being shorter than the inner magnetic layer.

10. A method of producing a multi-layered chip device, comprising:
preparing a plurality of inner magnetic layers including conductive patterns and via electrodes formed thereon;
forming a multi-layered body by stacking the plurality of inner magnetic layers so as to form a coil part by contacting ends of the conductive pattern formed in each of the inner magnetic layers to the via electrodes formed in adjacent inner magnetic layers;
stacking an outer magnetic layer on at least one of an upper surface and a lower surface of the multi-layered body;
partially removing both ends in a length direction of the multi-layered outer magnetic layer; and
forming external electrodes on outside of the outer magnetic layer of which the both ends are partially removed and the multi-layered body.

11. The method of claim 10, wherein the partially removing of the both ends includes: partially removing the multi-layered outer magnetic layer, based on a length of the outer electrode formed on the outside of the outer magnetic layer.

12. A chip device, comprising:
a support substrate;
coils formed on both surfaces of the support substrate;
a magnetic body including the coils and the support substrate and formed of a magnetic substance;
an outer magnetic layer formed on at least one of an upper surface and a lower surface of the magnetic body; and
external electrodes formed on outside of the multi-layered body and the outer magnetic layer and electrically connected to the coils,
a length of the outer magnetic layer being shorter than that of the magnetic body.

13. The chip device of claim 12, wherein a thickness of the outer magnetic layer is 0.9 to 1.1 times of that of the external electrode formed on the outside of the outer magnetic layer.

14. The chip device of claim 12, wherein a thickness of the outer magnetic layer is equal to that of the external electrode formed on the outside of the outer magnetic layer.
